(19) United States
(12) Patent Application Publication
(10) Pub. No.: US 2025/0377041 A1
(43) Pub. Date: Dec. 11, 2025

(54) SELF-ENERGIZING SEAL

(71) Applicant: Ronald Cheek, Long Beach, CA (US)

(72) Inventor: Ronald Cheek, Long Beach, CA (US)

(21) Appl. No.: 18/738,989

(22) Filed: Jun. 10, 2024

(51) Int. Cl. F16J 15/3212

(52) U.S. Cl. CPC F16J 15/3212

(57) ABSTRACT

A self-energizing seal for use in connection with an emissions control system to capture exhaust emissions from ocean going vessels when they are docked in port. The self-energizing seal including a sealing ring which is drawn into engagement with the exterior wall of the vessel's exhaust stack when a vacuum is drawn by the emissions control system.

### FIELD OF INVENTION

The subject invention relates to the field of emission recovery systems. More particularly to the field of emission recovery systems used to recover or capture exhaust emissions from ocean going vessels when they are in or near port.

### BACKGROUND

When ocean going vessels, such as container ships or oil tankers, are berthed in or near the port they typically run an auxiliary engine in order to generate electricity to power the operations of the ship while it is in port. These engines burn bunker fuel/diesel fuel. This generates significate quantities of toxic emissions or pollutants. These pollutants can pose a health hazard to port workers and residents living near the port.

Recognizing the need/desire to reduce, if not entirely eliminate, these toxic emissions various devices and systems have been developed in an effort to capture the emissions before they are discharged into the atmosphere.

One such system is shown in Caro, et al. U.S. Pat. No. 7,258,710. Another device and system is shown in Caro, et al., U.S. Pat. No. 8,075,651. Yet another is shown in Powell, et al., U.S. Pat. No. 8,402,746. Also, an exhaust intake bonnet is shown in Caro, et al., U.S. Pat. No. 8,808,415. Yet, other emission control systems are shown in Tonsich, U.S. Pat. No. 10,132,220; Tonsich, U.S. Pat. No. 10,287,940; and Tonsich, U.S. Pat. No. 10,422,260.

While these prior devices and systems attempt to address the issue of capturing undesired exhaust emissions, they all suffer from a common short coming in that they fail to properly engage the exterior of the vessel's exhaust stack and therefore fail to capture all of the emissions.

### SUMMARY OF THE INVENTION

The subject invention is a self-energizing seal that is used in connection with an exhaust emissions control system. The self-energizing seal is positioned over the exhaust stack of an ocean going vessel. During use, the self-energizing seal engages the exterior of the exhaust stack and forms an airtight seal which prevents loss or blow by of the emissions and enables the emissions control system to capture all of the emissions exiting the vessel's stack without drawing in outside air.

The overall system includes an emissions control system or unit which is mounted on a barge. The barge allows the emissions control system to be positioned next to the vessel while it is docked at a berth in the harbor or at an anchorage waiting to be docked. The emission control system processes the toxic exhaust gases captured from the exhaust stack and releases clean exhaust gas into the atmosphere.

The emissions control system is connected to the vessel's exhaust stack by means of an exhaust conduit which is connected at one end to the emissions control system and at the distal end to the self-energizing seal which is lowered over and engages the exhaust stack.

In operation, the emissions control system draws a vacuum through the exhaust conduit which in turn causes the self-energizing seal to engage the exhaust stack resulting in the exhaust gases being drawn through the exhaust conduit and into the emissions control system.

### BRIEF DESCRIPTION OF THE DRAWINGS

FIG. 1 is a drawing of an emission control system incorporating the self-energizing seal;

FIG. 2 is perspective view of the self-energizing seal positioned on the exhaust stack of a vessel;

FIG. 3 is a side view of the self-energizing seal positioned on the exhaust stack of a vessel;

FIG. 4 is a cross-sectional view taken along line 4-4 in FIG. 3.

FIG. 5 is a cross-sectional side view of the self-energizing seal positioned on the stack of a vessel;

FIG. 6 is a cross-sectional view of the self-energizing seal positioned on the stack of a vessel;

FIG. 7 is a view of a sealing ring;

FIG. 8 is a cross-sectional view of a sealing ring taken along line 8-8 in FIG. 7; and

FIG. 9 is a perspective view of a spring clip.

### DETAILED DESCRIPTION OF THE PREFERRED EMBODIMENTS

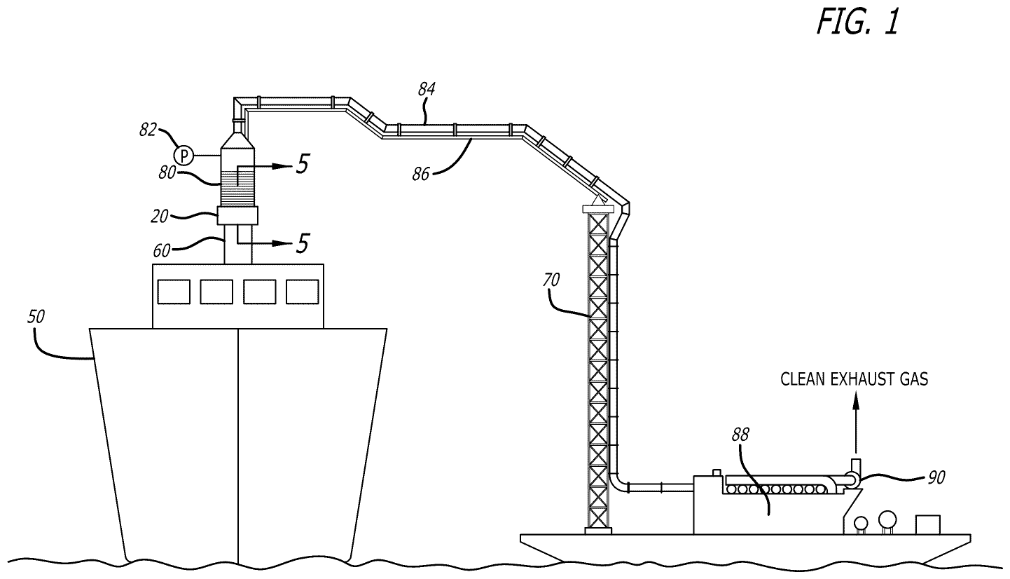

The exhaust emission control system which incorporates the self-energizing seal at the subject invention is shown in FIG. 1. An emission control system 88 is positioned on a barge. The emission control system is connected to an ocean going vessel 50 by means of an exhaust conduit 84. In a preferred embodiment, the exhaust conduit is thirty (30) inches in diameter. However, those skilled in the art will recognize that exhaust conduits of differing diameters could be use. The exhaust conduit 84 is connected to and extends upward along support tower 70. A placement or support boom 86 extends from the top of support tower 70. As shown in FIG. 1 placement boom 86 is positioned beneath and supports exhaust conduit 84.

At the distal end of the exhaust conduit 84 a pressure transducer 82 is provided which in turn is connected to a flexible hose or conduit 80. Self-energizing seal 20 is provided at the end of flexible conduit 80. In use the self-energizing seal 20 is lowered over exhaust stack 60 on ocean going vessel 50.

Although the emission control system is shown mounted on a barge, those skilled in the art will understand that it could be mounted on the dock adjacent the vessel's berth.

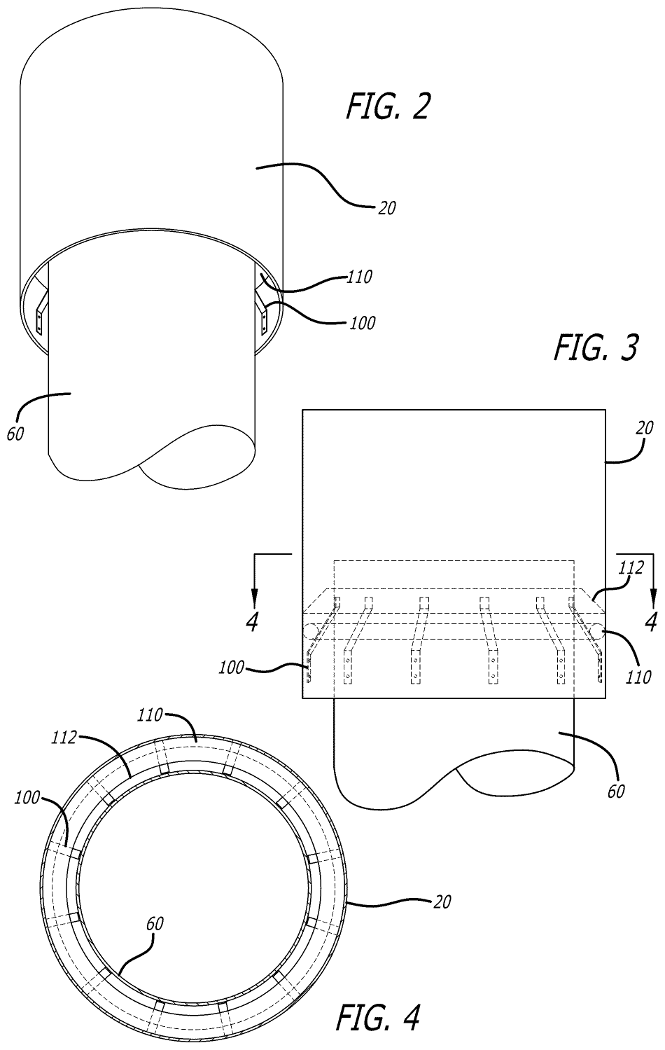

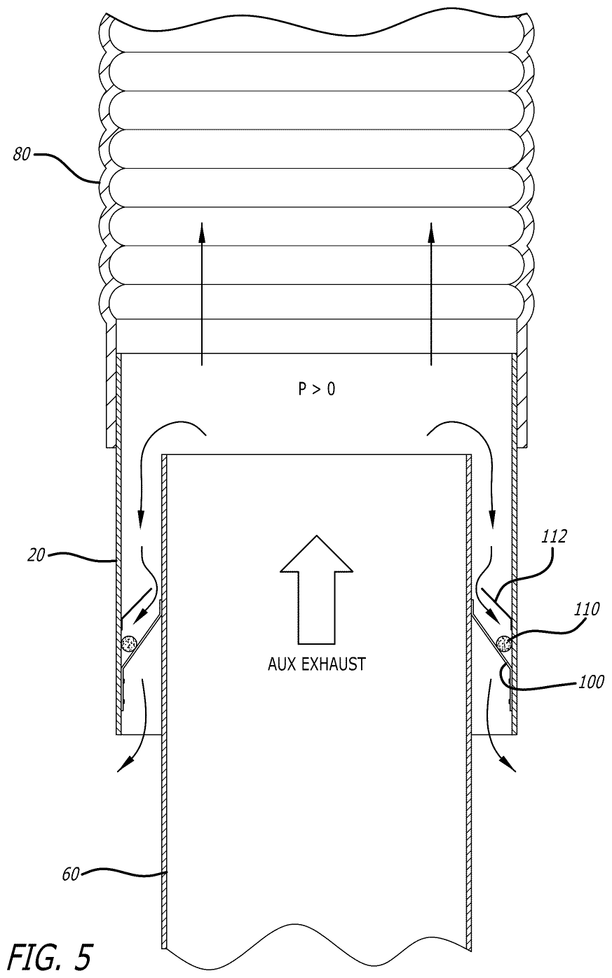

The engagement of the self-energizing seal 20 and the exhaust stack 60 is shown in FIGS. 2, 3 and 4. As shown in FIG. 3, a conical sleeve 112 is mounted on the interior wall of the self-energizing seal 20. The sleeve 112 may be connected to the interior wall of the self-energizing seal 20 by means of spot welding, rivets or other connection means know to those skilled in the art. In a preferred embodiment, the sleeve is angled at approximately 60 degrees from the vertical axis of the self-energizing seal 20. In a preferred embodiment, the sleeve 112 is sized to provide approximately a 0.5 inch gap between the interior edge of the sleeve and the exterior wall of the exhaust stack 60. A plurality of spring members 100 are spaced around the interior of the seal 20. As shown in FIG. 5, the spring members 100 are mounted beneath conical sleeve 112. The spring members 100 engage the exterior wall of the exhaust stack 60 when the seal 20 is lowered over the exhaust stack. By being flexible, the spring members 100 are capable of engaging exhaust stacks of differing diameters. A circular floating seal 110 rests atop spring members 100. In a preferred embodiment, the spring members 100 are positioned at an angle of approximately 60 degrees from the vertical axis of the self-energizing seal 20.

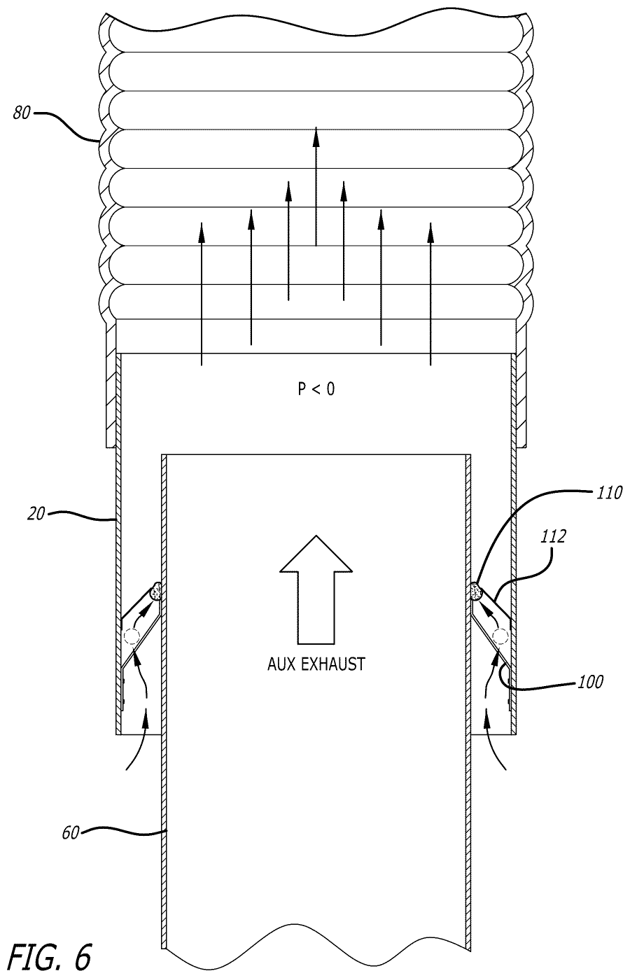

The operation of the self-energizing seal 20 is illustrated in FIGS. 5 and 6. As shown in FIG. 5, the seal 20 is lowered over exhaust stack 60. When the self-energizing seal 20 is first lowered over exhaust stack 60, the pressure in the flexible hose 80 is positive. The exhaust gases can then escape the self-energizing seal 20 by flowing downward and out the bottom of the seal into the atmosphere.

As shown in FIG. 6, when a vacuum is drawn on the exhaust conduit 84 and flexible hose 80 via induced fan 90, the floating seal 110 is drawn upward and engages the exterior wall of the exhaust stack forming a seal between the exhaust stack 60 and the conical sleeve 112 which prevents exhaust gases from escaping through the bottom of the seal. Rather, all of the exhaust gases are drawn upward into flexible hose 80 and in turn through exhaust conduit 84 and into emission control system 88. In a preferred embodiment, there is approximately a half inch gap between the interior edge of the conical sleeve 112 and the exhaust stack 60.

As shown in FIG. 1, the self-energizing seal 20 is lowered downwardly in a vertical direction over exhaust stack 60. However, on some vessels, the exhaust stack may be curved and not extend upwardly in a straight vertical line. The incorporation of flexible hose 80 allows the self-energizing seal 20 to be connected to the exhaust stack regardless of the orientation of the mouth of the exhaust stack.

As shown in FIG. 1, a variable speed induced draft fan 90 is provided on the emission control system 88. In operation the induced draft fan 90 draws the exhaust gases from the exhaust stack 60 through the self-energizing seal 20 and flexible hose 80 and exhaust conduit 84 into the emission control system 88 where it is processed and clean exhaust gas is then discharged into the atmosphere.

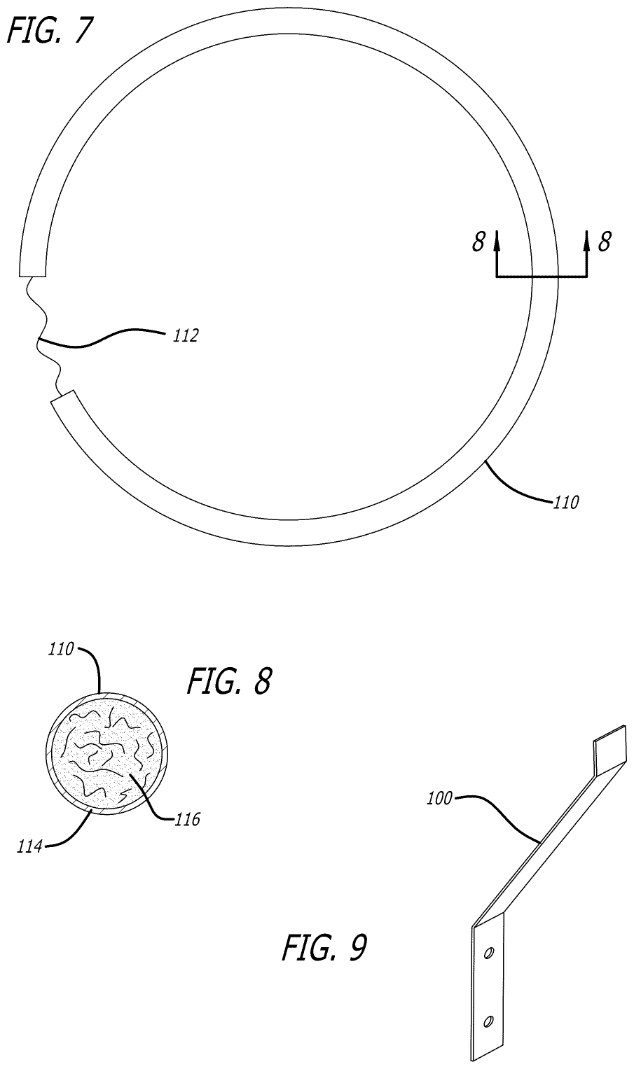

The floating seal 110 is shown in FIG. 7. As shown, it is a semi-circular ring with the ends of the ring connected by an elastic tether 116. The tether allows the floating seal to adjust to fit exhaust stacks of differing diameters.

The composition of the floating seal 110 is shown in FIG. 8. The external cover or sheath 114 of the seal is made from a high temperature and abrasion resistant material such as Keular. The internal material 116 in the floating seal 110 is a ceramic or fiberglass packing material known to those skilled in the art.

While the invention herein disclosed has been described by means of specific embodiments numerous modifications and variations could be thereto by those skilled in the art without departing from the scope of the invention set forth in the claims.

I claim:

1. A self-energizing seal for capturing emissions from exhaust stacks when said seal is positioned over said exhaust stacks comprising:
a cylindrical tube having an internal wall and an external wall;
a plurality of spring members mounted on the internal wall of the cylindrical tube;
a conical sleeve mounted on the internal wall of the cylindrical tube and positioned above the plurality of spring members; and
a circular seal positioned atop the spring members and below the conical sleeve.

2. The self-energizing seal of claim 1 wherein:
the spring members engage the exterior wall of the exhaust stack.

3. The self-energizing seal of claim 1 wherein:
the conical sleeve encircles the exhaust stack without engaging the exhaust stack.

4. The self-energizing seal of claim 1 wherein:
the circular seal is sized to fill the gap between the exterior wall of the exhaust stack and the conical sleeve.

5. The self-energizing seal of claim 1 wherein:
the conical sleeve is angled at approximately 60 degrees from the vertical axis of the seal.

6. The self-energizing seal of claim 1 wherein:
the conical sleeve extends to approximately one-half inch of the exterior wall of the exhaust stack.

7. The self-energizing seal of claim 1 wherein:
the circular seal is comprised of a high temperature abrasion resistant material with a fiberglass packing internal material.

8. The self-energizing seal of claim 7 wherein:
the internal packing material of the seal is ceramic.

9. An exhaust emission control system for capturing emissions from exhaust stacks comprising:
an emission control system;
an exhaust conduit'
a pressure transducer;
an induced draft fan; and
a self-energizing seal comprised of a cylindrical tube having an internal wall and an external wall;
a plurality of spring members mounted on the internal wall of the cylindrical tube;
a conical cone mounted on the internal wall of the cylindrical tube and positioned above the plurality of spring members; and
a circular seal positioned atop the spring members and below the conical cone.

10. The exhaust emission control system of claim 9 where:
the emission exhaust control system is mounted on a barge.

11. The exhaust emission control system of claim 9 wherein:
The proximal end of the exhaust conduit is connected to the emission control system and the self-energizing seal is connected to the distal end of the exhaust conduit.

12. The self-energizing seal of claim 9 wherein:
the spring members engage the exterior wall of the exhaust stack.

13. The self-energizing seal of claim 9 wherein:
the conical sleeve encircles the exhaust stack without engaging the exhaust stack.

14. The self-energizing seal of claim 9 wherein:
the circular seal is sized to fill the gap between the exterior wall of the exhaust stack and the conical sleeve.

15. The self-energizing seal of claim 9 wherein:
the conical sleeve is angled at approximately 60 degrees from the vertical axis of the seal.

16. The self-energizing seal of claim 9 wherein:
the conical sleeve extends to approximately one-half inch of the exterior wall of the exhaust stack.

17. The self-energizing seal of claim 9 wherein:
the circular seal is comprised of a high temperature abrasion resistant material with an fiberglass packing internal material.

18. The self-energizing seal of claim 9 wherein:
the internal packing material of the seal is ceramic.

19. The self-energizing seal of claim 1 wherein:
the spring members are angled at approximately 60 degrees from the vertical axis of the seal.

20. The exhaust emission control system of claim 9 where:
the spring members are angled at approximately 60 degrees from the vertical axis of the seal.
